(19) United States
(12) Patent Application Publication
(10) Pub. No.: US 2014/0365476 A1
(43) Pub. Date: Dec. 11, 2014

(54) VIRTUAL TAG, CLIENT HOSTED AND CLIENT SOURCED CONTENT/SERVICES RATING AND RANKING SUPPORT

(71) Applicant: BROADCOM CORPORATION, IRVINE, CA (US)

(72) Inventors: Yasantha Nirmal Rajakarunanayake, San Ramon, CA (US); James Duane Bennett, Hroznetin (CZ); Wael William Diab, San Francisco, CA (US)

(73) Assignee: BROADCOM CORPORATION, IRVINE, CA (US)

(21) Appl. No.: 13/956,289

(22) Filed: Jul. 31, 2013

Related U.S. Application Data
(60) Provisional application No. 61/833,269, filed on Jun. 10, 2013.

(51) Int. Cl. G06F 17/30

(52) U.S. Cl. CPC G06F 17/30241; G06F 17/3053
USPC 707/724; 707/723

(57) ABSTRACT

A technique in which a tag associated with a target object is sent to a user device to provide information regarding the target object. The tag includes a rating indicator for a recipient of the tag to respond to the rating indicator, in which the rating indicator is used to request a rating of one or more characteristics related to the target object. The rating response is collected with verification information to determine a level of verification of the rating response, in which the verification may include reliability of the rater providing the rating response. The response and level of verification are used to rank the rating response and provide further filtering of the tag related to the target object.

### CROSS REFERENCE TO RELATED APPLICATION

The present U.S. Utility Patent Application claims priority pursuant to 35 U.S.C. §119(e) to U.S. Provisional Patent Application No. 61/833,269, entitled, “Virtual Tag, Client Hosted and Client Sourced Content/Services Rating and Ranking Support,” filed Jun. 10, 2013, which is incorporated herein by reference in its entirety for all purposes.

### BACKGROUND

1. Technical Field

The embodiments of the present disclosure relate to ratings provided by target recipients and verifying the ratings for ranking purposes.

2. Description of Related Art

Communication infrastructures rely on a number of search techniques and/or search engines to allow a user to search for various content accessible to the user via a network, such as the Internet. In a typical content search, a user inputs a search term or phrase for use with a search engine, such as Google™ or Yahoo™, to initiate a search. The search engine utilizes a crawler to navigate through various web sites accessible via the Internet or, alternatively, searches through cached data sites containing a list of recently searched or popular web sites. The search engine provider then uses some form of filtering to categorize and order the found sites for presentation to the searcher (e.g. the user).

A user may utilize a search to locate a product, service or content that the user is interested in. A user may search for a product to buy, a service to be performed or content to be consumed (e.g. watching a movie). In these instances where the user is a consumer of a product, service or content, the user may be interested in providing an opinion or review of the consumed product, service or content. For example, a person may search for a restaurant, go to the restaurant, order a meal and provide a critique of the food or the restaurant. Likewise, a person may search for an automobile repair shop to have his/her car repaired. After having the repair, the car owner could post a review of the service received. Similarly, a person could search for a movie content provider, locate the desired movie and download the movie for consumption. After watching the movie, the viewer can critique the movie and/or the download service received.

In these instances, where the consumer provides comments, reviews and/or critiques, the consumer's responses are entered at a particular web site. For example, movie watchers may post consumer responses at sites such as IMDb™ (Internet Movie Database), product shoppers may post product reviews at sites such as Amazon™ and service providers may be reviewed on sites such as Yelp™. The responses may be posted on various blogs as well. These consumer and/or business review sites are generally accessed by connecting to a website via a Uniform Resource Locator (URL) or clicking on a link that contains the URL. The responses may then be posted.

However, with most posts, there are no means available to verify the authenticity or veracity of the responders review. A person may not watch a movie, but still provide a review. A person may not have his/her car serviced at a garage, but still provide a review. A person may not go to a restaurant and order a meal and still provide a response. Accordingly, significant amount of fraud may be perpetrated at such review sites and very few mechanisms are available for the viewer to filter posted reviews.

Furthermore, in a limited way some items are now being tagged with a geographic location identifier. For example, people who take photos may now add a geolocation identifier to link the physical location to the photo. In some instances, the person may manually enter the location identifier (such as latitude and longitude), but for many cameras today, a snapped photo may be linked to a location coordinate determined by a Global Positioning System (GPS). The GPS location tagging is being employed more and more to other forms of tagging. As an example, geo-tags and virtual tags are now being employed with business locations to entice or direct a customer to the business. However, even though geo-tags may direct a customer to a business, reviews of such businesses are still provided by accessing an URL of one of the review sites.

### BRIEF DESCRIPTION OF THE DRAWINGS

FIG. 1 shows a system diagram of an example network connecting a number of different devices and a target object via a tag-based search engine, in which a tag is used to link one or more devices to the target object and to elicit a response relating to the target object.

FIG. 2 shows a system diagram of an example scenario in which tags are used to link target objects that provide a product to a plurality of devices, in which recipients of the tags respond by providing a rating response to the tag-based search engine regarding the product.

FIG. 3 shows a system diagram of an example scenario in which tags are used to link target objects that provide content to a plurality of devices, in which recipients of the content respond by providing a rating response to the tag-based search engine regarding the content.

FIG. 4 shows a system diagram of an example scenario in which tags are used to link target objects that provide service to a plurality of devices, in which recipients of the service respond by providing a rating response to the tag-based search engine regarding the service.

FIG. 5 is an example flow diagram of a device that links to a target object and receives a tag related to the target object and generates a response to rate one or more characteristics of the target object.

FIG. 6 is an example flow diagram of a tag-based search engine that provides a tag to a recipient device, receives a rating response from the recipient device and processes the rating to provide ranking information regarding the tag.

FIG. 7 is an example block diagram of a device that a tag related to a target object and responds by rating one or more characteristics related to the target object.

FIG. 8 is an example block diagram of a tag-based search engine that receives a rating response from a recipient of a tag and processes the response to determine a level of verification for the response in order to rank the response.

FIG. 9 is an example user interface on a display that is used to elicit a response from a recipient of a product or service associated with the target object.

FIG. 10 is an example user interface on a display that is used to elicit a response from a recipient of a content associated with the target object.

FIG. 11 shows a system diagram of an example network integrating web-based searching with the tag-based search engine and rating response processing.

### DETAILED DESCRIPTION

The embodiments described below may be practiced in a variety of networks that utilize wired, wireless or optical connections, or any combinations thereof. One or more such networks may include the Internet and/or the World Wide Web (WWW). The network may be public, private, virtual or any combination thereof. The devices on the network may utilize one or more communication protocols to communicate via the network, including various IEEE (Institute of Electrical and Electronic Engineers) specified protocols, ITU (International Telecommunication Union) specified protocols, as well as others, and utilizing various addressing schemes, including Internet Protocol (IP) addressing.

Furthermore, various devices, such as mobile phones, tablet computers, personal computers (PCs), are described, however, other devices not described herein may be used in the interaction described in this disclosure. In addition, although implementation examples are noted herein, the implementation is not limited to such disclosed embodiments.

For embodiments implementing a geolocation described herein, any of a variety of geolocation schemes is applicable. For example, locations may be determined by using latitude and longitude coordinates. A more prevalent technique is the use of GPS, in which geolocation coordinates are determined by receiving timing signals from a plurality of GPS satellites and determining the location by timing differentiation.

The disclosure references a variety of terms which are defined as follows:

Rating Interface: An item or data that interfaces with a user to provide an opportunity for generating a rating. The disclosure describes a tag (such as a geolocation tag or a virtual tag) as a rating interface, but the rating interface need not be associated with a tag. For example, a rating interface may be downloaded from a web server for rating input.

Rated or Target Object: The object (e.g. product/service) being rated for generation of a rating.

Rater: A person providing a rating of the target object via the rating interface.

Spatial Relationship: Pertains to a spatial relationship between the location of the target object and location of the rater providing the rating related to the target object.

Time Relationship: Pertains to the time lapse between the time the rating interface is provided to the rater and when the rater submits the rating of the target object.

Rating Viewer: Is a person who views the rating, verification of the rating or reliability of the rater, or a combination thereof.

The disclosure describes a delivery of a rating interface (or data associated with the rating interface) associated with a target object, obtaining of a rating from a rater related to the target object, determining verification of the rating along with reliability of the rater, and providing a result to a rating viewer. In one embodiment, the result may be a tailoring ratings directed to a rating viewer, based not only on a possible legitimacy of the rating, but also on a correlation between the rater and the rating viewer.

Thus, verification or reliability comprises a plurality of data that are be considered as a whole and depend on the nature of (i) the rated object, (ii) the rating interface, (iii) the rater, and (iv) the spatial and time relationships, as well as interactions among (i-iv). Accordingly, a rater may provide a rating that may be discounted or have elevated impact based on the seeming legitimacy of the rating and this rating may be tailored to a particular rating viewer.

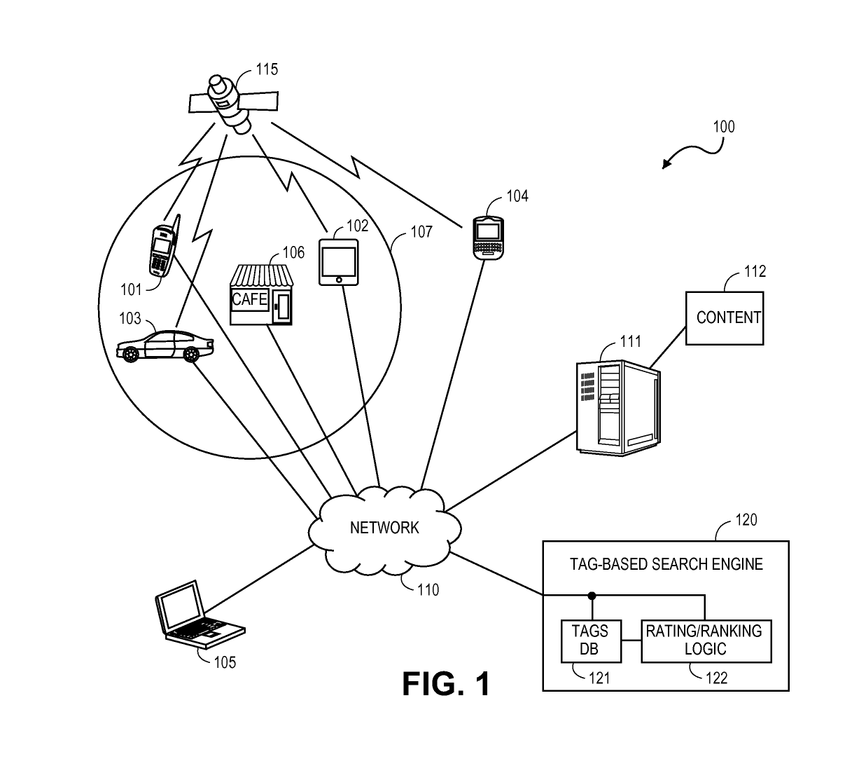

FIG. 1 shows a system diagram of an example network connecting a number of different devices and a target object via a tag-based search engine, in which a tag is used to link one or more devices to the target object and to elicit a response relating to the target object. In FIG. 1, a system 100 is shown that includes a variety of devices 101-105 configured to operate with a network 110, which may be one or more of a variety of networks, as described above. The devices may be mobile or stationary. In the particular example for system 100, device 101 is a mobile phone (e.g. cell phone, smartphone, etc.), device 102 is a tablet computer, device 103 is a device affixed in a vehicle (e.g. a communication device or GPS navigation system with dual communication link), device 104 is another mobile phone and device 105 is a notebook computer or a personal computer (PC). It is to be noted that other types of devices may be present within system 100.

The various devices within system 100 may have geographical location (geolocation) capability to determine the location of the respective devices on earth and in some instances, altitude information may be presented as part of the geolocation determination. In the example of system 100, devices 101-104 are shown linked to a GPS satellite 115 to obtain GPS geolocation. Only one satellite 115 is shown, but it is noted that timing signals from multiple GPS satellites are used for determining the geolocation of a device. Notebook computer 105 is not linked for geolocation determination, but in other embodiments it could be so linked.

It is to be noted that other mechanisms for determining geolocation information may be used. For example, other co-located device(s) may deliver the geolocation information. Non-GPS schemes involving earthbound location determining anchor devices may be used. Such devices may be used indoors or where GPS lock is unattainable. Coarse locationing via wireless access point attachment may be used. For example, a course location may be inferred from knowing the location of an underlying wireless access point. Coarse locationing via wired service pathway inference may be used, such as when a known wired access or hop provider serves a particular region. Coarse locationing through routing address may be used to determine a location, such as using an IP or MAC address to cross into a region wherein such addresses are available for providing service. Furthermore, location inference may be used, such as when a person receives a tag from being within a required proximity of such a tag, it may be assumed that the person is at the appropriate geolocation.

A café (or coffee shop) 106 is shown also linked to network 110. Café 106 has its own website with its unique URL, or some other means of providing a website, that allows the public to access the web site to obtain information about café 106. The website may contain various types of information about the café, such as a menu, days and hours of operation, available discounts, direction on finding the café and other sundry details dealing with the business operation of café 106. The website and its content may be located at café 106, but typically, the website may be managed at another location, as shown by server 111 and content 112.

In a common scenario, when a user of a device, such as one of the devices 101-105 wants information about an eating establishment or coffee shop in a particular area, a search engine may be used to search for such business operations in an area (e.g. town, city or portions thereof). Assuming that café 106 pops up as part of the search, the searcher may then link to the website of café 106 to view information about the business at café 106. If specials or discounts are available, the user then can download appropriate e-coupons, etc. for use at café 106.

In a similar scenario, a mobile device linked to GPS has the capability of identifying its location. Hence, when a search is conducted from such a geolocation capable device, the device may be capable of localizing the search to a proximate area about the device. Thus, a person in a vehicle using device 103 may search for a coffee shop within a proximate area to the vehicle or a person using mobile phone 101 may search for a coffee shop within a proximate area of the user's location. Mobile applications (apps) may be present on the device to make such searches simpler. For example, a chain coffee shop may have an app to identify a number of the chain's coffee shops within a pre-designated distance from the mobile device containing the app. Thus, a person wandering the streets of a city can quickly identify the nearest coffee shop for the chain of coffee shops.

Once café 106 is located by a mobile user, the mobile user may then access the café's website to obtain information about café 106. When an app is present, a link may be provided to allow the user to link to the website of café 106. The user may seek information about café 106, such as directions to reach café 106 and may download e-coupons for discounts, etc.

Whether the user accesses the website by website searches or by geolocation tied to the location of the user's device, the access allows the user to connect to the website of café 106, or some equivalent location, to obtain information about café 106. When such a link is made to the café's website by the user to access the content of the website, the website may also provide a tag that sends an e-coupon, or some other means, to entice the user to visit café 106. The tag associated with the café may contain a rating indicator to elicit a rating review or response regarding some aspect of café 106. The tag functions as a rating interface, in which the rating indicator is included within tag data (e.g. rating interface data). For example, a tag sent to the person may inquire as to what product on the menu was purchased and the person's review about the purchased product. It is to be noted that this rating interface may be downloaded from a website in other embodiments.

In a different scenario, café 106 may have a capability of identifying mobile devices that enter a pre-established boundary set for café 106. In system 100, boundary 107 is shown for café 106, so that devices within boundary 107 may be contacted to provide various information regarding café 106. This process is different from the above-described scenarios in that the users of the various devices do not perform an active search for café 106.

For example, in an environment where a mobile device with geolocation capability is roaming, the device may be set to receive various geolocation or virtual tags. For example, in one scenario, a mobile device may operate an app that allows virtual apps of a particular business to send a tag to the mobile device. For example, a person attending a music festival in a particular city may download an app for the music festival that sends tags pertaining to the various music venues. The same app or a different app may allow tags pertaining to eating and drinking establishments to be sent to the mobile devices.

In another scenario, a person may select to receive a particular class or type of tags, or even all tags, pertaining to various businesses, venues, etc. within a locale or located within a certain distance from the mobile device. Such tag submission may be based on the location of the particular mobile device and its proximity to the location of the target object (such as café 106). Thus, such tags (e.g. geolocation tags, virtual tags or non-location specific tag) sent to the user may contain some indicator that a response is solicited when the person has some interaction with the target object. For the café example, such indicator may request the person's review of the product procured at café 106, priced paid for the item, quality of service provided, cleanliness of the premise, etc. In general, a rating indicator associated with a tag permits the person receiving the tag to rate one or more characteristics related to the target object.

It is to be noted that such tags eliciting a rating may be contained with the website content 112 of café 106. However, in one embodiment, such tags are maintained in a tag-based search engine so that tags may be treated separately from the website content. In this manner, tags may be updated without updating the website content. In addition, tags may be sent separate from or without the website content. Hence, in the description above where tags are sent to roaming mobile devices, the tags may be tied to an entity that monitors the geolocation of a mobile device.

In system 100, a tag-based search engine 120 is used to provide tags to devices 101-105. Search engine 120 may be one apparatus or multiple devices at located at different locations. The tags are stored in a tags database (DB) 121 and search engine 120 searches for a given tag based on the request. For example, if the initial connection is through a web search as noted above, a website connection also links to a corresponding tag in tag DB 121 to send the corresponding tag to the searching device. If the tag transmission is based on geolocation of the device (without website access), then the entity monitoring the location of the particular device accesses the corresponding tag and sends the tag to the device. In some instances, the device, the monitoring entity and/or the target object may place certain constraints on the transmission of the tag to the device.

Tag-based search engine 120 also includes a rating/ranking logic 122, which is used to provide the rating indicator and process or filter the rating response. Logic 122 may also perform ranking operations as noted below.

When a tag is sent to a user device from tag DB 121, a corresponding rating indicator is also sent. The rating indicator elicits some form of rating input from the user of the device. The rating indicator seeks a response from the user that pertains to one or more characteristics related to the target object. The response may be objective and/or subjective. The response may also request a comment from the person regarding the target object. The response is typically a review of the person's experience with the target object of the tag. However, in some instances it may have other relationships to the target object. The response provided by the user of the device receiving the tag is captured and stored within search engine 120 or some other storage location.

The response is then ranked with other responses related to the tag. In a simple objective response based on a value (e.g. rate between 1-5 stars or a numerical value between 1 and 10, inclusive), the rating value may be combined with other responses for the same tag and calculations performed (e.g. obtain a new average) to arrive at a new rank value, or some other means of measure relating to the target object.

In addition to receiving a response and using the response for ranking, logic 122 also performs a verification operation to verify the authenticity or veracity of the response. As noted above, reviews and opinions regarding products, services and content may be suspect without further evaluation. It may be that a consumer did dislike the drink item consumed at café 105, but such a review is difficult to differentiate from someone placing a negative rating without even visiting café 106. Accordingly, logic 122 provides some level of verification check to determine if the response is genuine. Likewise, logic 122 may also perform a reliability check or analysis related to the rater as part of the verification.

A number of schemes are available to perform a verification check or at least determine a level of verification for the response, as well as determine reliability of the rater. For example, if the target object is café 106 (or product or service offered by café 106), then the tag that was sent to the device may send back with the response, the geolocation of the device when the response was sent. Accordingly, a spatial relationship is established between the location of the target object and location of the rater when sending the rating response. If the geolocation of the device sending the response is at or near the geolocation of café 106, then an assumption may be made that the person visited café 106, thereby giving a higher level of verification (higher confidence) for the response.

The time and date may be taken into account as well for establishing a time relationship. Thus, someone who received the tag regarding café 106 generates a response 15-30 minutes after receiving the tag has a close time relationship between receiving the tag and generating the rating response. A rating submitted days or weeks later would have a longer elapsed time relationship. The time relationship may be used for verification and reliability. For example, a rating of a consumed product, such as coffee, may be suspect if the rating is submitted weeks or months after consuming the product. Alternatively, a person purchasing a durable product in response to a tag and submitting a rating response within mere minutes would also be suspect, since the rating is made without actual use of the product.

The time relationship may be used in conjunction with spatial relationship in some instances. For example, if a person receiving the tag responds minutes later with a rating response from another city, then the verification would place a much lower confidence level to the response. Likewise, a multiple number of responses from the same user device in a given day or short period of time would indicate a low confidence level, or even fraud in driving down the business for the café. Other examples abound to determine a level of confidence or verification for a given response or group of responses.

Likewise, reliability of the rater may be taken into account as well. If, for example, the particular rater has a history of providing consistently negative (or positive) ratings, then the rater may not be providing an honest rating of the target object. Therefore, rater reliability in providing the rating response may be considered as part of the verification and taken into consideration when determining the ranking.

Then, when ranking the response, logic 122, which may have associated software, places the response within the overall rank and/or generates a combined ranking value for a plurality of responses related to the tag. Where the verification level is low (or below a set threshold), the response may be ignored, since the response may be suspect. Thus, only responses meeting a certain verification level are deemed valid and used for ranking the target object.

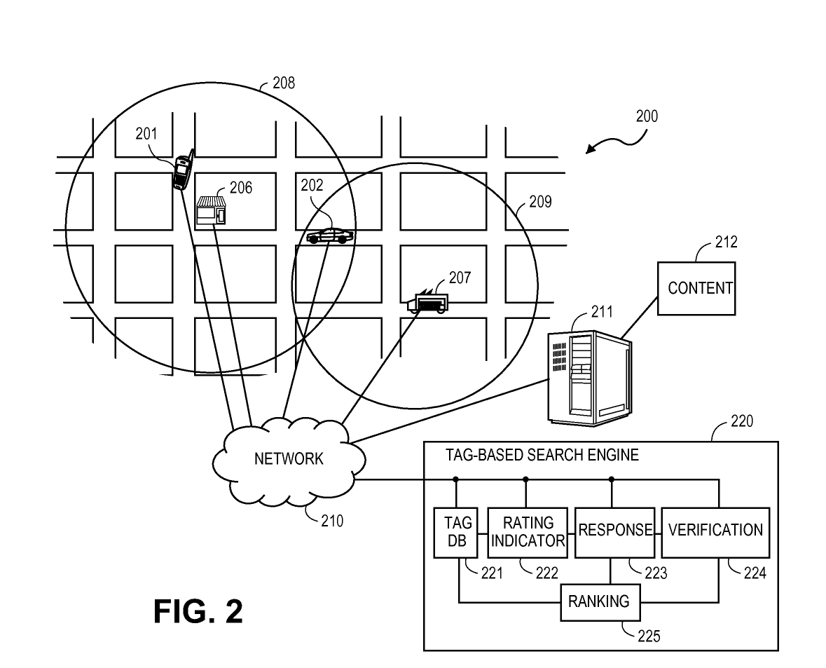

FIG. 2 shows a system diagram of an example scenario in which tags are used to link target objects that provide a product to a plurality of devices, in which recipients of the tags respond by providing a rating response to the tag-based search engine regarding the product. FIG. 2 shows a system 200, which may be an implementation of system 100 of FIG. 1. In system 200, a city grid pattern is shown in which café 206 is at one location and mobile food van 207 is at another location. A mobile phone 201 and a mobile communication device within vehicle 202 are also shown. The geolocation of the three mobile devices 201, 202, 207 are determined, such as by use of GPS. The geolocation of café 206 is also known. Mobile devices 210, 202, 207, as well as café 206 are linked to network 210. A server 211 and associated content 212 are also linked to network 210. A tag-based search engine 220 is also linked to network 210.

Similar to above, café 206, as well as mobile food van 207, may have corresponding websites describing their business operations. If a website is present, the website may link to a corresponding tag in a tag DB 221 of search engine 220, so that when the website is accessed, a link is made to the tag DB 221 to search and obtain the tag associated with the respective target object. Thus, someone accessing the website of food van 207 may receive a tag associated with food van 207.

Similarly to above, café 206 may cause a tag to be sent to a mobile device that enters its established boundary 208 for sending tags. In system 200, both mobile phone 201 and vehicle 202 are within boundary 208 for sending tags of café 206. Likewise, food van 207 may cause a tag to be sent to a mobile device that enters its established boundary 209 for sending tags. In system 200, vehicle 202 is within boundary 209, but mobile phone 201 is not. Thus, a tag associated with food van 207 may be sent to vehicle 202, but not mobile 202, based on geolocation. Note also that since food van 207 is mobile, food van may change its location that may put mobile phone 201 within its boundary and, at such point, may send a tag to mobile phone 201.

A tag is sent from tag DB 221 of search engine 220, once the appropriate tag(s) is/are searched for the locations noted. With tags sent to either mobile phone 201 or vehicle 202, a rating indicator is included to have the recipient of the tag respond with a rating response. As noted above, a variety of responses may be elicited from the recipient of the tag. A rating indicator module 222 of search engine 220 contains an indicator that is sent with a tag. A generic rating indicator may be sent or one that is customized to the particular tag depending on the system and the rating scheme or profile used. A response from a recipient of the tag is stored in response storage 223, along with any information used for determining the level of verification, as well as rating/rater reliability. As noted above, the level of verification or confidence level may be determined by verification module 224 by analyzing returning information, such as geolocation of the tag recipient sending the response, time and date of the response, number of responses from the recipient device, rater's history, etc. and comparing the information to the location of the target object and date and time the tag was sent to the recipient device (or received by the recipient device).

Then a ranking module 225 is used to process the verification level with the returned rating response to either provide a rank to attribute to the response and/or derive a combined rank of a plurality of responses received for the same tag or target object. The ranking process may take an additional filtering step in some instances to discredit certain tags or a target object that fails to meet a certain ranking threshold. For example, a tag that consistently results in recipients sending negative ratings may delist that tag and/or the associated target object completely. Thus, a food van that consistently receives poor ratings from recipients receiving the tags associated with the food van, may have the tags delisted from the tag DB 221, so consumers no longer receive information, e-coupons, etc. related to the food van. Other means may be used to deal with target objects receiving low ratings. Rater/rating reliability may be considered as well as part of the verification and ranking processes.

Alternatively, those tags eliciting high rating responses with high level of verification may have additional tags generated or the tag boundary expanded to cover a wider area. Other means may be used to deal with target objects receiving high ratings.

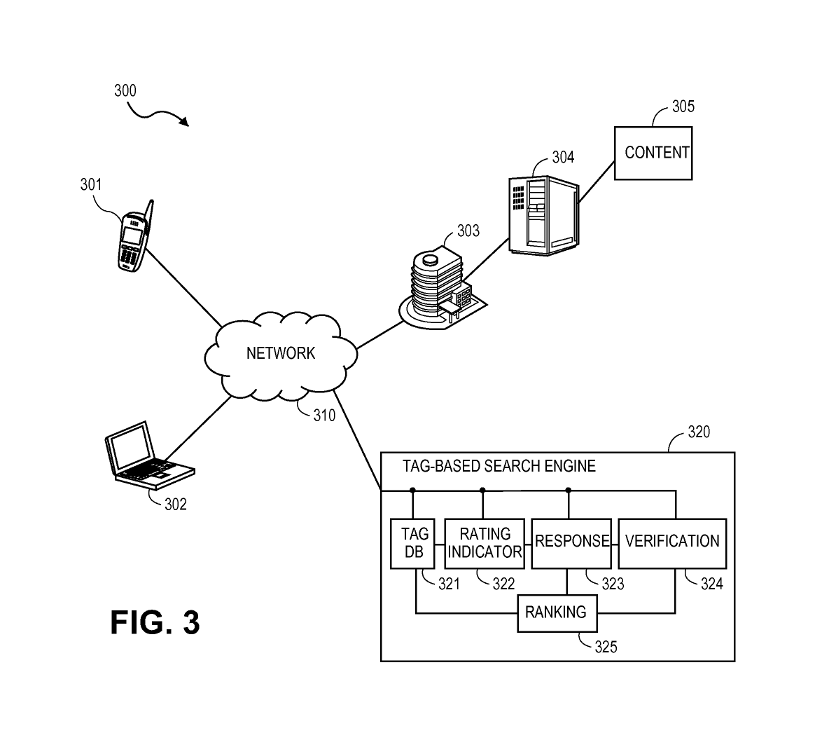

FIG. 3 shows a system diagram of an example scenario in which tags are used to link target objects that provide content to a plurality of devices, in which recipients of the content respond by providing a rating response to the tag-based search engine regarding the content. FIG. 3, which may be an implementation of system 100 of FIG. 1, shows a system 300 in which a mobile phone 301 and a notebook computer 302 are linked to a network 310 and tag-based search engine 320. In this example, the target object is a content provider 303 that provides content for consumption by devices that connect to server 304 to download content 305. In the example, mobile phone 301 and notebook computer 302 are consumption devices for content 305. Assuming that a tag associated with a particular movie is resident in tag DB 321 of tag-based search engine 320 and mobile phone 301 receives the tag along with a download of a particular movie. Note that the particular movie may have been searched by mobile phone 301 and the tag provided as a result of the search, or the tag may have been pushed to mobile phone 301, such as a promotion of a release of a movie as downloadable content. In any event, mobile phone 301 receives a tag associated with a movie provided.

The tag may be used to link to the download of the content (e.g. the movie) and also to provide payment, digital rights management (DRM), etc. The tag may also include a rating indicator to elicit a response from the recipient once the movie is watched. A rating indicator module 322 may contain the rating indicator that is sent with the tag. A generic rating indicator may be sent or one that is customized to the particular tag depending on the system and the rating scheme or profile used. A response from a recipient of the tag is stored in response storage 323, along with any information used for determining the level of verification. As noted above, the level of verification or confidence level may be determined by verification module 324 by analyzing returning information. Rater/rating reliability may be considered as part of verification.

In this particular example, geolocation is not utilized, since the rating pertains to the content and not to a specific location of the target object. Accordingly, a verification procedure may rely on other factors instead of geolocation. For example, once the tag and the content are downloaded, the content within mobile phone 301 may be monitored to determine if the mobile phone plays the movie for viewing on mobile phone 301. The movie may be monitored to determine if the complete movie is played for viewing or only a portion is viewed. The verification process for content may even use the mobile phone's camera to monitor eye movement of the recipient to actually determine if the recipient watched the played movie. The date time stamp of the response sent by the tag recipient may be compared to the date and time when the movie was played on mobile phone 301 for viewing. Thus, where geolocation is not used with the target object, verification may still be performed with rating response related to the target object.

A ranking module 325 would then combine the rating response and verification to arrive at a ranking to give to the rating response or combine the rating with other ratings for an overall rank or score. Other examples abound.

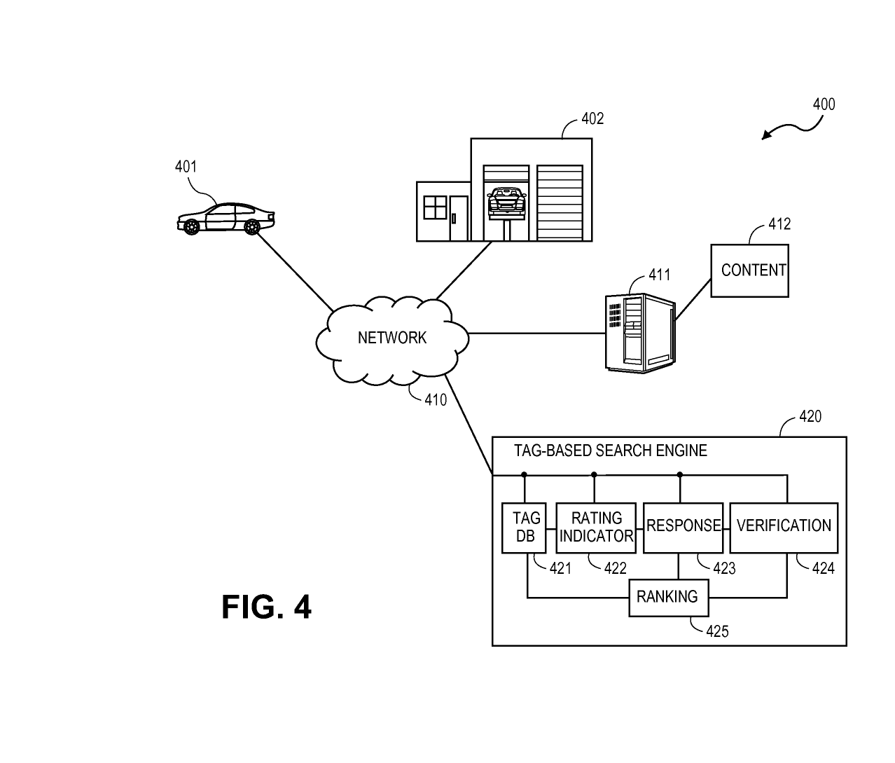

FIG. 4 shows a system diagram of an example scenario in which tags are used to link target objects that provide service to a plurality of devices, in which recipients of the service respond by providing a rating response to the tag-based search engine regarding the service. This scenario is similar to that described in FIG. 2, but now pertains to a service. FIG. 4 shows a system 400, which may be an implementation of system 100 of FIG. 1. In system 400, a vehicle 401 that includes a geolocation capable device is linked to network 410. A server 411 and associated content 412 are also linked to network 410. A tag-based search engine 420 is also linked to network 410. An automobile repair facility (e.g. garage) 402 is also linked to network 410.

Garage 402 may have a corresponding website describing its business operations. If a website is present, the website may be located at server 411 and linked to a corresponding tag in a tag DB 421 of search engine 420, so that when the website is accessed, a link is made to the tag DB 421 to search and obtain the tag associated with the garage operation. Thus, someone accessing the website of garage 402 may receive a tag associated with auto repair work.

Alternatively, garage 402 may cause a tag to be pushed to vehicle 401 based on some constraint established with vehicle repair. For example, if garage 402 specialized on repairing a particular make of automobiles, then garage 402 may push tags to such make of automobiles in a surrounding area and may provide a discount for auto repair. A geolocation boundary may be used as well, wherein a particular make of automobile entering the garage's set boundary may be pushed a tag from tag DB 421.

With a tag sent to vehicle 401, a rating indicator is included to have the recipient of the tag respond with a rating response. As noted above, a variety of responses may be elicited from the recipient of the tag. A rating indicator module 422 of search engine 420 contains an indicator that is sent with a tag. A generic rating indicator may be sent or one that is customized to the particular tag depending on the system and the rating scheme or profile used. A response from a recipient of the tag is stored in storage 423, along with information used for determining the level of verification. As noted above, the level of verification or confidence level may be determined by verification module 424 by analyzing returning information, such as geolocation of the tag recipient sending the response, time and date of the response, number of responses from the recipient device, rater's history, etc. and comparing the information to the location of the target object and date and time the tag was sent to the recipient device (or received by the recipient device).

Then a ranking module 425 is used to process the verification level with the returned rating response to either provide a rank to assign to the response and/or derive a combined rank of a plurality of responses received for the same tag or target object. Other examples abound. Other means may be used to deal with target objects receiving low ratings.

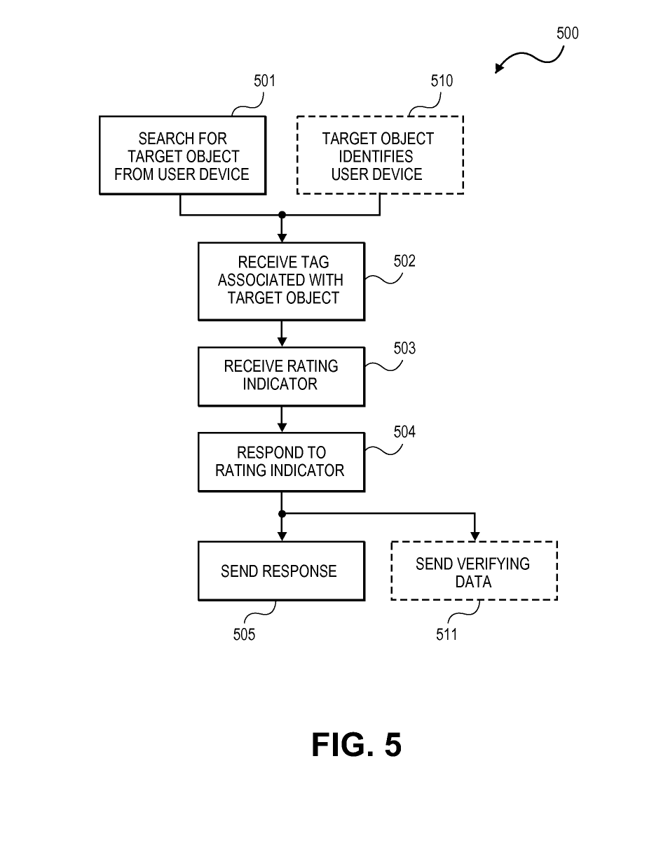

FIG. 5 is an example flow diagram of a device that links to a target object and receives a tag related to the target object and generates a response to rate one or more characteristics of the target object. In flow diagram 500, a device (either fixed or mobile) either searches for a target object (e.g. product, service, content, etc.) (block 501) or, alternatively, the user device is identified by the target object or some entity associated with the target object (block 510). Once the user device is identified, a tag associated with the target object is sent to the user device (block 502). Included with the tag is a rating indicator that is received by the user device (block 503). The rating indicator contains a request for a rating of one or more characteristics related to the target object. The recipient of the tag then responds to the rating indicator by entering a response, typically by user interaction via a user interface (block 504). The response is then sent to a destination that is set for the response (block 505). If any verifying data are to be sent (e.g. geolocation, date, time, content viewing, etc.), the data is sent along with the rating response (block 511).

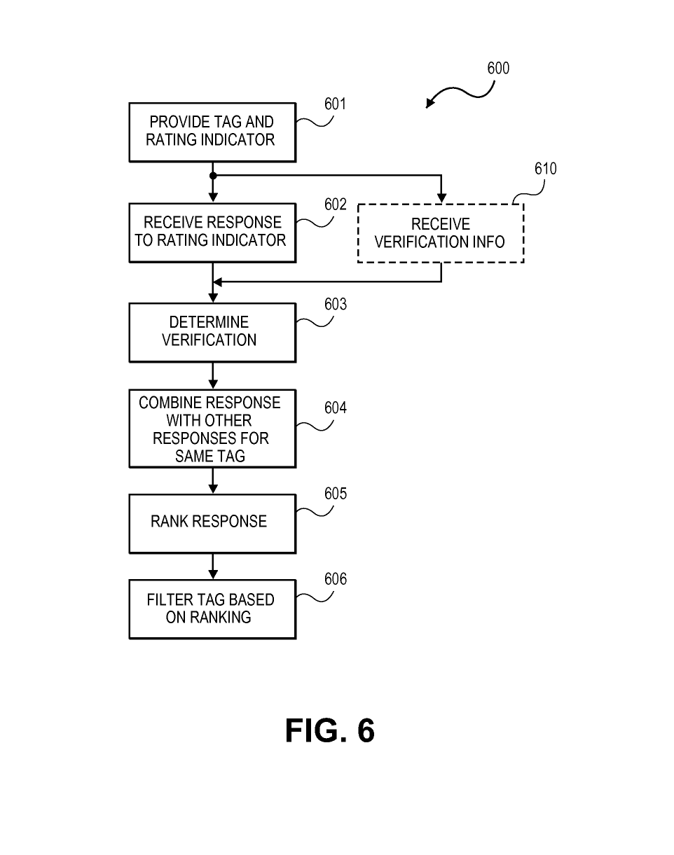

FIG. 6 is an example flow diagram of a tag-based search engine that provides a tag to a recipient device, receives a rating response from the recipient device and processes the rating to provide ranking information regarding the tag. In flow diagram 600, a tag-based search engine provides a tag and rating indicator for sending to a recipient device (block 601). The rating indicator contains a request for a rating of one or more characteristics related to the target object. The tag may have been a result of a search (such as a web search) initiated by a user and linked to the tag by the object of the search, or the tag may be a result of pushing the tag to a recipient (e.g. proximal geolocation to a target object). Subsequently, a rating response is sent from the recipient of the tag (block 602). Verification information may be received as well (block 610).

Then, using the response and the verification information, if present, the response is evaluated for a level of verification or confidence level (block 603). If the response is not removed for receiving a poor verification, such as not meeting a selected threshold level, the response is combined with other responses (block 604) to arrive at a rank value for the response to rank the target object (block 605). The rank value may be combined with the other responses to obtain a combined or cumulative rank for the target object. In some instances, further filtering may be performed based on the ranking (block 606). Such filtering may involve delisting the tag for the target object is the ratings are poor or for lack of response from the recipients of the tags.

As exemplified above, diagram 600 shows a delivery of a tag (which contains or is associated with a rating interface data) associated with a target object, obtaining a rating from a rater related to the target object, determining verification of the rating (which verification may also determine reliability of the rater/rating), and providing a result, which may be to a rating viewer. As part of the verification process (block 603), a plurality of data that are be considered as a whole and depend on the nature of (i) the rated object, (ii) the rating interface (e.g. the tag), (iii) the rater, and (iv) the spatial and time relationships, as well as interactions among (i-iv).

As part of verification, a rating interface may be considered for reliability. For example, a rating indicator sent along with a geo-location associated tag to a consumer may have higher confidence level than a web downloaded rating indicator.

The rated object may also be considered. For example, certain target objects may be more susceptible to subjective review versus objective review, so that a certain review by a rater may question the rater's reliability. Also, a rating score that is atypical (high variance) from past rating scores may be suspect as to the rater's legitimacy.

As part of the verification process, a rater's profile may be available so that certain profile information may be used. For example, young people or people of a certain sex may have more favorable (or unfavorable) opinion of a particular target object. Thus, where such profiles are available, the variation in the rater's profile may be used to determine a certain level of verification. A difference in ranking may be taken into consideration when such constraints are used. For example, older people may rate a theater production much higher than someone in his/her teens.

The spatial and/or time relationship, as previously discussed above, may be taken into consideration for determining the verification of the rating response, as well as the rater's reliability.

The rater's history may also be taken into account as well. If a rater has a history of providing legitimate rating responses in the past, a higher confidence may be given to that rater's ratings. Alternatively, a rater with extreme variations (e.g. ratings generally beyond an “average” or “median” values) or a rater known to submit fraudulent rating responses may be given lower confidence or ignored outright. Accordingly, a rater may provide a rating that may be discounted or have elevated impact based on the seeming legitimacy of the rating.

In addition, the verified responses when being ranked (block 605) and/or as part of the filtering (block 606) may be further tailored to a particular viewer (or a group of viewers) that will view the ranked response. Instead of viewing just the ranking result, a viewer may also have access to the individual rating responses used in the ranking. Accordingly, in one embodiment, the result may be a tailored ratings directed to a rating viewer, based not only on a possible legitimacy of the rating, but also on a correlation between the rater and the rating viewer.

In addition, in one embodiment, if a viewer wants to read details from a given rater, such rater may also receive a rating that is relevant to the viewer. For example, if a person is a rating viewer that never rates, the viewer profile information may be used with correlation to the rater, such that the viewer sees a rating for the object and a rating for the rater that both may be tailored for that viewers own relevance. For example, the viewer may see an overall ranking of 7.6 out of 10 and an adjusted (tailored for the viewer) ranking of 8.1 out of 10 based on the viewer profile and/or history. When probing for a first rater's comments and rating contribution, the viewer may see a 6 out of 10 object rating, a 6.5 adjusted object rating, a first rater correlation of 9.5, a first rater overall rating of 7.2, and a first rater correlation rating of 8.9. Another viewer may see the overall ranking of 7.6, but with an adjusted ranking of 3.2. When probing, the second viewer sees the 6 object rating by the first rater but with a 2.4 adjusted object ranking, a first rater correlation of 0.4, the first rater overall rating of 7.2, and a first rater correlation rating of 3.1 (e.g., how good this rater's ratings are predicted to be for the first viewer).

Alternatively, the first rater's contributions may be tossed entirely from all ranking information provided to the second viewer due to correlation problems. Similarly, if the first rater's rating has low verification data, such rater's contributions may also be tossed entirely from even ranking information delivered to the first viewer, even though strong correlation exists. In other words, many non-adjusted and adjust ratings (of an object, a rater, all raters, a group of raters, etc.) may be produced specifically for a particular viewer based on such viewer's profile information, past related viewer ratings, past viewer objective rating behaviors, etc. Accordingly, as part of ranking and filtering, a rating from a rater, along with the rater, may be correlated to a particular viewer based on that viewer's profile, rating activity and/or viewing activity. The correlations may be established for a plurality of raters of a target object and/or a plurality of viewers of the target object ratings.

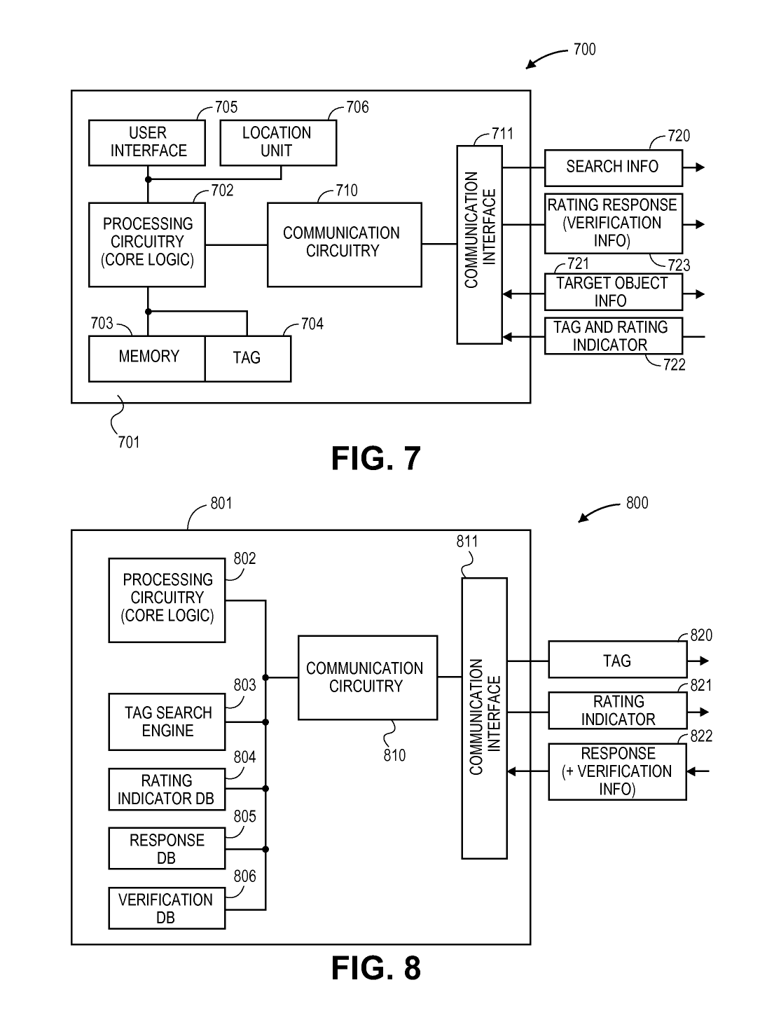

FIG. 7 is an example block diagram of a device that processes a tag related to a target object and responds by rating one or more characteristics related to the target object. Device 701 of diagram 700 may be one of the devices shown in FIGS. 1-4 or any other device. Device 701 includes a processing circuitry (or core logic) 702 coupled to a memory 703, which may have a portion 704 for containing instructions for operating on the tag and generating rating responses. Device 701 also includes communication circuitry 710 and communication interface 711. Device 700 may also include a user interface 705 and a location unit 706.

User interface 705 may include one or more input components (e.g. keyboard, touch screen, microphone, etc.) and/or output components (e.g. display, speaker, headphone, etc.) for user interaction with device 701. Location unit 706, when present, provides geolocation capability for device 701, such as using GPS timing signals to determine the geolocation of device 701.

Processing circuitry 702 includes one or more core logic components for providing processing functions for device 701. Processing circuitry 702 may also execute programs that provide various functions and applications for device 701. Processing circuitry 702 may initiate searches for a target object (e.g. website searches) by providing search parameters or information, which is noted as search info 720 and receive returning information pertaining to such searches, noted as target object info 721.

Processing circuitry 702 also receives a tag (weather linked to a search or by having the tag pushed to device 701) that includes a rating indicator, which is noted as tag and rating indicator 722. After obtaining user input via user interface 705, processing circuitry 702 sends a rating response along with verification information 723, if any verification information is present. Reliability information may be present as well as part of the verification.

Memory 703 may contain various programming instructions to be executed by processing circuitry 702 as well as data. As noted, a portion 704 of memory is used for instructions used for operating on the tag, rating indicator, response to the rating indicator and verification information.

Communication circuitry 710 provides one or more communication related functions, such as coding/decoding, modulation/demodulation, signal conversion, etc. based on the type of communication used. Communication interface 711 then provides the interface for transmission and reception of communication signals to and from device 701.

FIG. 8 is an example block diagram of a tag-based search engine that receives a rating response from a recipient of a tag and processes the response to determine a level of verification for the response in order to rank the response. Device 801 of diagram 800 may be an equivalent tag-based search engine shown in FIGS. 1-4 or any other device. Device 801 includes a processing circuitry (or core logic) 802 coupled to a search engine 803, tag DB 804, response DB 805 and verification DB 806, communication circuitry 810 and communication interface 811.

Processing circuitry 802 includes one or more core logic components for providing processing functions for device 801. Processing circuitry 802 may also execute programs that provide the tag searching to locate appropriate tag(s) in tag DB 803 associated with a target object, locate corresponding rating indicator in rating indicator DB 804 and send the tag 820 with the rating indicator 821 to a recipient device. Device 801 then receives a response and verification information (if any) 822 and stores the response in response DB 805 and verification information in verification DB 806. Then, processing circuitry 802 executes routines to analyze the response and the verification information, if any, received from the recipient to determine a level of verification (confidence level) and rank the response, which ultimately supports the overall rating provided regarding the target object. Processing circuitry 802 may also provide the filtering for rater/rating viewer correlation as well.

Communication circuitry 810 provides one or more communication related functions, such as coding/decoding, modulation/demodulation, signal conversion, etc. based on the type of communication used. Communication interface 811 then provides the interface for transmission and reception of communication signals to and from device 801.

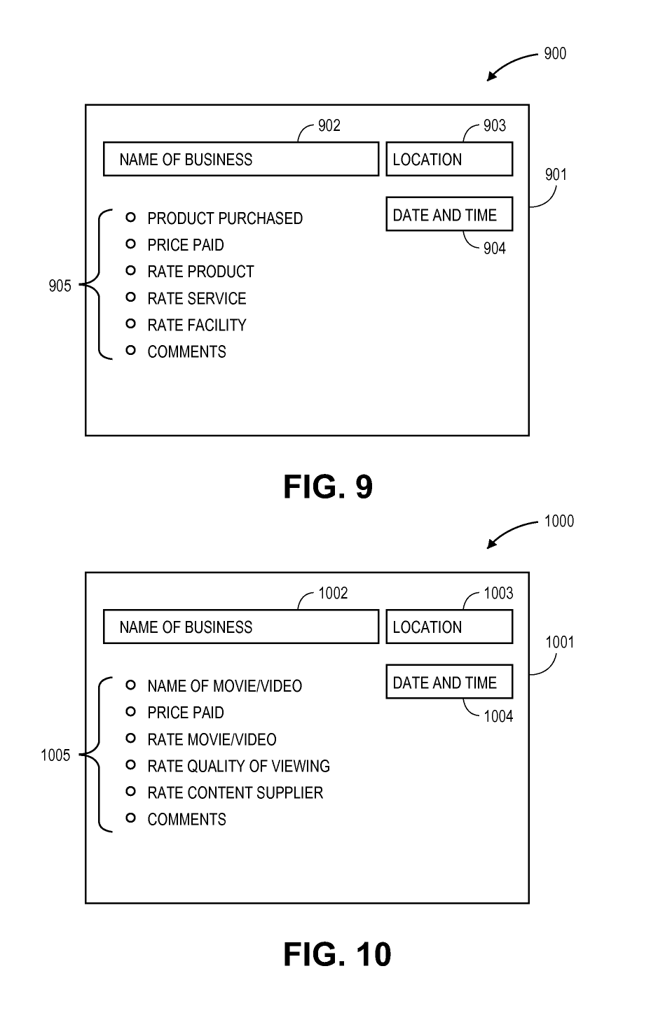

FIG. 9 is an example user interface on a display that is used to elicit a response from a recipient of a product or service associated with the target object. User interface 900 is one example embodiment that may be used to interface with a user and elicit a response from the user who is a recipient of a tag. Interface 900 shows a window 901 that may be displayed on a display to provide some form of input (e.g. keyboard, touch screen, voice recognition, etc.) from the user to generate a rating response. Window 901 shows a name of the business (which may be the target object) 902, location of the business 903 (which may be an address or it may be a geolocation) and date and time 904. A number of menu entries 905 are present in which when a given entry is selected, the menu expands with additional entries or presents an expanded or new window.

It is to be noted that the menu entries shown are for example purpose and more or less entries may be present in other embodiments. Window 901 may be applicable for rating a product associated with the target object. Accordingly, an entry noted as product may be used to identify a procured product. Price entry may be used to identify the price paid for the product. An objective or subjective rating may be input at the entry for rating the product. Rate service entry allows for rating a service provided at the business. The premises may be rated under the rate facilities entry and subjective comments entered under the comments entry.

Once the user inputs the various responses presented by interface 900, the response is submitted, along with any verification information. A similar window may be used to identify a service provided by a business, such as the afore-mentioned automobile repair facility.

FIG. 10 is an example user interface on a display that is used to elicit a response from a recipient of a content associated with the target object. User interface 1000 is one example embodiment that may be used to interface with a user and elicit a response from the user who is a recipient of a tag. Interface 1000 shows a window 1001 that may be displayed on a display to provide some form of input (e.g. keyboard, touch screen, voice recognition, etc.) from the user to generate a rating response. Window 1001 shows a name of the business (which may be the target object) 1002, location of the business 1003 (which may be an address or it may be a geolocation) and date and time 1004. A number of menu entries 1005 are present in which when a given entry is selected, the menu expands with additional entries or presents an expanded or new window.

It is to be noted that the menu entries shown are for example purpose and more or less entries may be present in other embodiments. Window 1001 may be applicable for rating a content. In the specific example, window 1001 pertains to movie or video downloaded for viewing. Accordingly, an entry noted as name of movie/video may be used to identify the content for consumption. Price entry may be used to identify the price paid for the content. An objective or subjective rating may be input at the entry for rating the movie/video. Rate quality of viewing entry allows for rating the quality of the content being viewed. The rate content supplier rates the downloading experience and subjective comments may be entered under the comments entry. Once the user inputs the various responses presented by interface 1000, the response is submitted, along with any verification information.

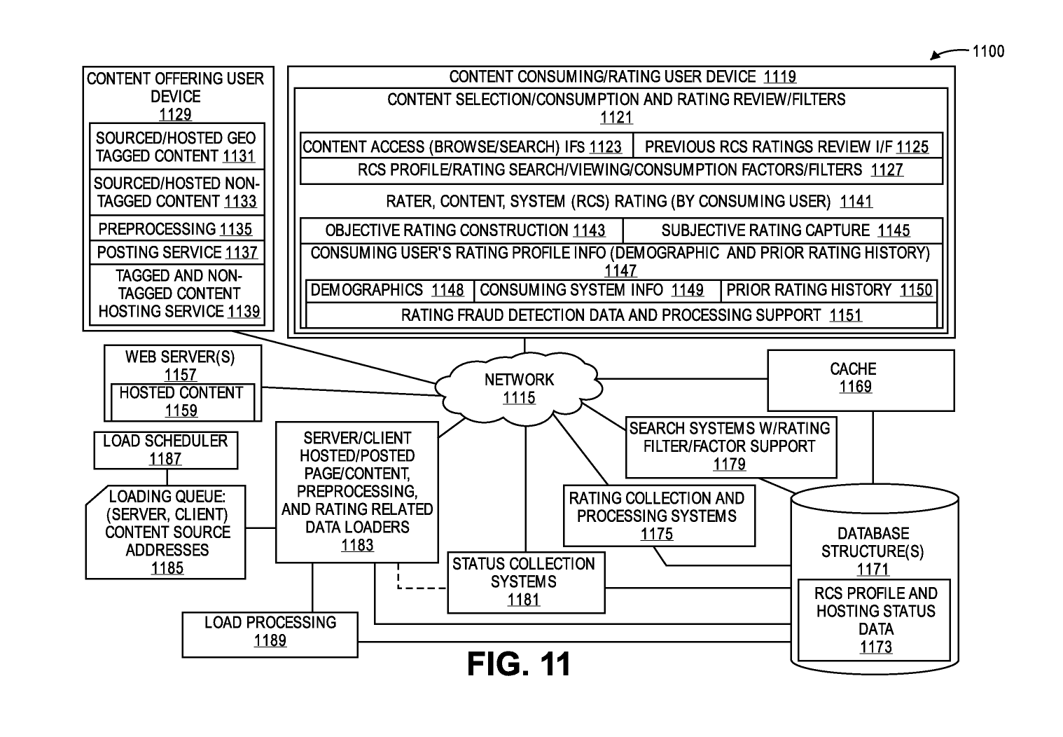

FIG. 11 shows a system diagram of an example network integrating web-based searching with the tag-based search engine and rating response processing. FIG. 11 shows a system 1100 that integrates the above-described tag-based infrastructure with the search infrastructure currently in practice. System 1100 of FIG. 11 includes one or more user device 1119 that is configured to operate as a user device that is a recipient of tags pulled or pushed to user device 1119. In one embodiment, user device is equivalent to the user devices described in reference to FIGS. 1-4. User device 1119 includes a content selection/consumption and rating review/filters module (or section) 1121 and a rater, content, system (RCS) rating module (or section) 1141. Content selection/consumption and rating review/filters module 1121 may include a content access interface module 1123 to provide for website access and content browsing. Content selection/consumption and rating review/filters module 1121 may also include a previous RCS ratings review interface module that contains or links to previous ratings that may be accessed and viewed by the user to determine other ratings of a target object. Content selection/consumption and rating review/filters module 1121 may also include a RCS, content, system rating module 1127 to allow user to access and view searched content, ratings of the respective target object, downloaded content for viewing or other consumption of downloaded content, tags and information provided by tags, rating indicators associated with tags and any filtering to be done on the downloaded data if filtering is to be performed.

Rater, content, system rating module 1141 is used for providing rating response and verification information to a tag search engine or other entity collecting the rating response from the recipient of the tag (e.g. user device). Rater, content, system rating module 1141 may include an objective rating construction module 1143 to construct objective data or questionnaire for rating one or more characteristics of the target object. Rater, content, system rating module 1141 may also include a subjective rating capture module 1145 to capture user's subject responses, such as comments to be posted by the user regarding the target object.

Rater, content, system rating module 1141 may include a consuming user's rating profile information module 1147 that may be used to collect user profile or device operations for purposes of verification. Module 1147 may include a demographics module 1148 to collect demographic information of the user, a consuming system information module 1149 to collect items, tags, content, etc., which are consumed by the user's device, and a prior rating history module 1150 to collect user's prior ratings. Rater, content, system rating module 1141 may provide the information in modules 1148, 1149, 1150, along with date, time and/or geolocation information as part of the response or, alternatively, conduct part of the verification procedure within rating fraud detection and processing support module 1151.

It is to be noted that some of the modules may not be present or used with user devices in other embodiments, while other processing modules may include other processing modules not shown. Furthermore, the various modules shown maybe performed by hardware, software, firmware, apps or a combination thereof. In one embodiment the apparatus shown in FIG. 7 may be configure to provide the functions of the modules of device 1119.

System 1100 of FIG. 11 includes one or more content/tag offering device 1129 that is configured to operate as a source of the content and/or tag sent to user device 1119. In one embodiment, device 1129 is equivalent to the tag-based search engine described in reference to

FIGS. 1-4 regarding the sourcing of tag. Device 1129 may contain a sourced/hosted tagged content (which may include geotags) 1131 and/or sourced/hosted non-tagged content 1133. A preprocessing module 1135 may provide for preprocessing of the tags for transmission, including the rating indicator, and posting service module 1137 may provide for posting of the tag or non-tagged content to a user device (e.g. device 1119). If the rating indicator is hosted by another device, posting service 1137 may generate a link to a rating indicator source to have the rating indicator sent to the user device along with the tag. Hosting service 1139 transmits the content, tag, rating indicator, etc. from device 1129.

It is to be noted that some of the modules may not be present or used with user devices in other embodiments, while other processing modules may include other processing modules not shown. Furthermore, the various modules shown maybe performed by hardware, software, firmware, apps or a combination thereof. In one embodiment the apparatus shown in FIG. 8 may be configure to provide the functions of the modules of device 1129.

A network 1115 within system 1100 provides for the network connection shown for the devices of system 1100. The rating response may be collected by device 1129, but in this example, a rating collection and processing system module 1175 links to network 1115 to collect the rating response. A status collection systems module 1181 links to network 1115 to collect verification information, including profiles of the user, geolocation of the user device, etc. The collected information is stored as RCS profile and hosting status data 1173 in a database structure 1171. A search system with rating filter/factor support module 1179 is used to provide the ranking and any filtering based on the verification information collected. A cache 1169 may be present to provide caching of data between DB structure 1171 and the network.

Existing systems or comparable techniques that provide equivalent functions for operating on user-initiated searches may be integrated with the tagged content scheme. For example, URL website searches and content searches may be integrated together, as noted above.

Thus, search engine module 1183 may provide various search functions related to server/client, hosted/posted page/content search, preprocessing and rating related data loads to access various locations via network 1115, including web server(s) 1157 and hosted content 1159 associated with the website. A crawler may also be present with module 1183 to provide web crawling tasks and to download content. A server 1185 may be used to identify and cache searched URLs, content, etc. A scheduler 1187 may also be present to schedule conventional web downloads and downloads may be sent to DB structure 1171 via load processing module 1189. Other systems may have more or less functional modules.

Network 1115 may be used to tie in the various components. As noted above, a variety of networks that utilize wired, wireless or optical connections, or any combinations thereof may be employed for network 1115. Network 1115 may be public (e.g. Internet), private (e.g. intra-network), virtual, or any combination thereof. The devices on the network may utilize one or more communication protocols and addressing schemes to communicate via the network. Although one network is show, it is to be noted that network 1115 may include multiple networks.

Thus, virtual tag, client hosted and client sourced content/services rating and ranking support is described. Various embodiments are capable of delivery of a rating interface (or rating interface data) associated with a target object that also delivers a rating indicator, obtaining a rating from a rater related to the target object (or product or service related to the target object), determining verification of the rating along with reliability of the rater/rating, and providing a result (e.g. ranking) to a rating viewer, which may be filtered based on a particular viewer (e.g. tailored to the particular viewer). In one embodiment, the result may be a tailoring of ratings directed to a rating viewer, based not only on a possible legitimacy of the rating, but also on a correlation between the rater/rating and the rating viewer.

The embodiments above have been described with the aid of functional building blocks illustrating the performance of certain functions. The boundaries of these functional building blocks have been arbitrarily defined for convenience of description. Alternate boundaries could be defined as long as the certain functions are appropriately performed. One of ordinary skill in the art may also recognize that the functional building blocks, and other illustrative blocks, modules and components herein, may be implemented as illustrated or by discrete components, application specific integrated circuits, processors executing appropriate software and the like or any combination thereof.

As may also be used herein, the terms “processor,” “processing circuitry,” “core logic” and/or “service logic” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. Some of the processing functions may be performed by software. Furthermore, such processing components may include, or configured to operate with, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information.

The term “module” is used in the description of the various embodiments presented. A module may include a processing module, a functional block, hardware, and/or software stored on memory for performing one or more functions as may be described herein. Note that, if the module is implemented via hardware, the hardware may operate independently and/or in conjunction software and/or firmware. As used herein, a module may contain one or more sub-modules, each of which may be one or more modules.

What is claimed is:

1. A method for supporting rating of an object, the object having a first geographical location, the method comprising:
delivering rating interface data associated with the object for presentation to a rater, the rater having a second geographical location;
receiving rating related information associated with the rater;
identifying a spatial relationship between the first geographical location and the second geographical location; and
producing at least one ranking based at least in part on the rating related information and the spatial relationship.

2. The method of claim 1, wherein the at least one ranking comprises a personalized ranking for a rating viewer.

3. The method of claim 1, wherein the producing of the at least one ranking is also based at least in part on a time lapse between the delivering of the rating interface data and the receiving the rating related information.

4. The method of claim 1, wherein the rating related information comprises a subjective rating by the rater.

5. The method of claim 1, wherein the rating related information comprises an objective rating by the rater.

6. The method of claim 1, wherein the producing of the at least one ranking is also based on a historical information related to the rater.

7. The method of claim 1, wherein the at least one ranking comprises a rating related to the object.

8. The method of claim 1, wherein the at least one ranking comprises a rating related to the rater.

9. The method of claim 1, wherein the producing of the at least one ranking is also based on a correlation between data associated with the rater and data associated with a rating viewer.

10. The method of claim 9, wherein the data associated with the rater comprises profile data of the rater.

11. The method of claim 1, wherein the producing of the at least one ranking is also based on a correlation between data associated with a plurality of raters and data associated with a rating viewer.

12. The method of claim 1, wherein the rating interface data is delivered via a tag.

13. A method for supporting rating and ranking of target objects comprising:
sending a tag associated with a target object to a recipient device;
sending a rating indicator to the recipient device, wherein the rating indicator includes a request for a rating of one or more characteristics related to the target object;
receiving a rating response regarding the rating of the one or more characteristics related to the target object from the recipient device;
determining a level of verification of the rating response; and
ranking the rating response to other responses associated with the target object based on recipient device's rating of the one or more characteristics related to the target object and the level of verification of the rating response.

14. The method of claim 13, wherein the tag is associated with procuring a product and the rating indicator is used to request a rating of the product.

15. The method of claim 13, wherein the tag is associated with procuring a service and the rating indicator is used to request a rating of the service.

16. The method of claim 13, wherein the tag is associated with procuring content for consumption and the rating indicator is used to request a rating of the content.

17. The method of claim 13, wherein the determining of the level of verification further comprises determining reliability of a rater providing the rating response.

18. An apparatus to support rating and ranking of target objects comprising:
a communication interface configured to receive a rating response to a rating indicator from a recipient device of the rating indicator, in which the rating indicator is sent to the recipient device when a tag associated with a target object is sent to the recipient device and in which the rating indicator includes a request for a rating of one or more characteristics related to the target object;
a core logic configured to receive the rating response to the rating indicator from the recipient device and to determine a level of verification of the rating response, and the core logic to rank the rating response to other responses associated with the target object when the level of verification meets a selected threshold, the verification also including reliability of a rater providing the rating response.

19. The apparatus of claim 18, wherein the tag is associated with a geolocation of the target object and the response includes a geolocation of the recipient device providing the response and wherein the core logic is configured to compare the geolocation of the recipient providing the response with the geolocation of the target object to determine the level of verification.

20. The apparatus of claim 18, wherein the core logic is configured to provide ranking of the rating response, at least in part, based on a rating viewer, in which the ranking is tailored to the rating viewer.
